(19) United States
(12) Patent Application Publication
(10) Pub. No.: US 2023/0401463 A1
(43) Pub. Date: Dec. 14, 2023

(54) FORECASTING SYSTEM

(71) Applicant: ACCESS SOFTWARE AUSTRALIA PTY LTD., Chatswood NSW (AU)

(72) Inventors: Geoffrey Osmond Cook, Queensland (AU); Laura Emily Rose Van Doore, Queensland (AU); Gregory Matthew Walker, Queensland (AU)

(21) Appl. No.: 18/035,852

(22) PCT Filed: Nov. 4, 2021
(86) PCT No.: PCT/AU2021/051298

§ 371 Date: May 8, 2023

(30) Foreign Application Priority Data
Nov. 6, 2020 (AU) 2020904058

(51) Int. Cl. G06N 5/02; G06Q 10/04

(52) U.S. Cl. CPC G06N 5/027; G06Q 10/04

(57) ABSTRACT

A system for calculating a forecast, the system including an input configured to receive user inputs, a display configured to present results of the forecast, a persistent memory configured to store configuration data, the configuration data including forecast rules for calculating forecast values and one or more electronic processing devices. In use the processing devices determine one or more forecast parameters in accordance with user input commands received via the input, the forecast parameters being input indicative of the forecast to be generated, construct a calculator using the configuration data and the forecast parameters, execute the calculator to calculate forecast values, generate a forecast representation using the forecast values and display the forecast representation.

### BACKGROUND OF THE INVENTION

The present invention relates to a system and method for calculating a forecast and in one particular example, to a method for optimising forecasting in a computer system.

### DESCRIPTION OF THE PRIOR ART

The reference in this specification to any prior publication (or information derived from it), or to any matter which is known, is not, and should not be taken as an acknowledgement or admission or any form of suggestion that the prior publication (or information derived from it) or known matter forms part of the common general knowledge in the field of endeavour to which this specification relates.

It is known to use computer systems to perform financial forecasting, for example to predict future revenue and expenditure for an operation, such as a business or company. Typically such forecasts involve a large number of variables, and require large numbers of calculations to be performed, generating a large volume of results data, including both forecast results and audit trail information indicative of how results were calculated. As a result, the typical approach to forecasting involves running a forecast and generating results data, which are then stored in a persistent memory, such as on a solid state drive, and more typically in a database, allowing the results to be accessed again at a later time. However, given the volume of data involved, this storage process, and subsequent retrieval of the stored data, is time consuming and can limit the ability to provide detailed audit information for these results.

Typically an individual using a forecasting tool will want to review a number of different forecasts, allowing them to understand what impact different revenue/expenditure patterns might have on the operation. Reviewing resulting forecasts quickly can be difficult given the large amounts of data involved and attempts having been made to provide graphical representations of expenses, revenues, and resulting balance sheet forecasts, allowing these to be more easily visualised.

An example of this is described in US2002/0059055, which describes a computer-implemented modelling, or planning, system provides a graphical user interface including a timeframe. Under user control, instances of component objects representing modelling entities can be displayed with respect to the timeframe for the input of time-related properties for the component objects. The component objects provide calculations in response to the time-related properties on properties of the component object for deriving an output comprising a time-series of output values. A resulting report can be generated based on the time-series of output values. The displayed instances of the component objects can be directly manipulated by the user in order to define the time-related properties. The direct graphical representation facilitates planning operations and enables accurate, rapid and easily understandable development of plans. Multiple scenarios can easily be generated using the system.

To help address the issue of managing multiple scenarios, a revision mechanism is provided that facilitates the return to a scenario modelled earlier. This is achieved by having the revision mechanism store results calculated for each of multiple forecasts in a series of linked entries, allowing these to be more easily navigated. However, it will be appreciated that this still requires multiple sets of calculations are performed and then indexed and stored in persistent memory. Consequently, the process of trialling new scenarios becomes time consuming and can limit the ability to provide detailed audit information, as one of these results may have been calculated from thousands of other movements.

### SUMMARY OF THE PRESENT INVENTION

In one broad form, an aspect of the present invention seeks to provide a system for calculating a forecast, the system including: an input configured to receive user inputs; a display configured to present results of the forecast; a persistent memory configured to store configuration data, the configuration data including forecast rules for calculating forecast values; and, one or more electronic processing devices configured to: determine one or more forecast parameters in accordance with user input commands received via the input, the forecast parameters being input indicative of the forecast to be generated; construct a calculator using the configuration data and the forecast parameters; execute the calculator to calculate forecast values; generate a forecast representation using the forecast values; and, display the forecast representation.

In one broad form, an aspect of the present invention seeks to provide a method for optimising forecasting in a computer system, the method including: storing configuration data in a persistent memory, the configuration data including forecast rules for calculating forecast values; and, in one or more electronic processing devices of the computer system: determining one or more forecast parameters in accordance with user input commands received via an input, the forecast parameters being input indicative of the forecast to be generated; constructing a calculator using the configuration data and the forecast parameters; executing the calculator to calculate forecast values; generating a forecast representation using the forecast values; and, displaying the forecast representation.

In one broad form, an aspect of the present invention seeks to provide a computer program product for calculating a forecast, the computer program product including computer executable code that when executed by one or more suitably programmed processing devices causes the processing devices to: determine one or more forecast parameters in accordance with user input commands received via an input, the forecast parameters being input indicative of the forecast to be generated; construct a calculator using configuration data including forecast rules for calculating forecast values and the forecast parameters; execute the calculator to calculate forecast values; generate a forecast representation using the forecast values; and, display the forecast representation.

In one broad form, an aspect of the present invention seeks to provide a system for optimising dynamic display of a financial forecast, the system including: an input configured to receive user inputs; a display configured to present results of the forecast; a persistent memory configured to store configuration data, the configuration data including forecast rules for calculating forecast values; and, one or more electronic processing devices configured to: determine one or more forecast parameters in accordance with user input commands received via the input, the forecast parameters being input indicative of the forecast to be generated; construct a calculator using the configuration data and the forecast parameters; execute the calculator to calculate forecast values; generate a forecast representation using the forecast values; and, display the forecast representation.

In one broad form, an aspect of the present invention seeks to provide a method for optimising dynamic display of a financial forecast in a computer system, the method including: storing configuration data in a persistent memory, the configuration data including forecast rules for calculating forecast values; and, in one or more electronic processing devices of the computer system: determining one or more forecast parameters in accordance with user input commands received via an input, the forecast parameters being input indicative of the forecast to be generated; constructing a calculator using the configuration data and the forecast parameters; executing the calculator to calculate forecast values; generating a forecast representation using the forecast values; and, displaying the forecast representation.

In one broad form, an aspect of the present invention seeks to provide a computer program product for optimising dynamic display of a financial forecast, the computer program product including computer executable code that when executed by one or more suitably programmed processing devices causes the processing devices to: determine one or more forecast parameters in accordance with user input commands received via an input, the forecast parameters being input indicative of the forecast to be generated; construct a calculator using configuration data including forecast rules for calculating forecast values and the forecast parameters; execute the calculator to calculate forecast values; generate a forecast representation using the forecast values; and, display the forecast representation.

In one embodiment the one or more electronic processing devices include a CPU (central processing unit) and the system includes RAM (random access memory), and wherein the calculator is executed using the CPU and RAM.

In one embodiment at least some of the forecast values are at least one of: non-persistent; not written to the persistent memory; not written to a database; held in non-persistent memory; and, are stored in RAM.

In one embodiment the one or more electronic processing devices are configured to: acquire user input commands via the input, the user input commands being indicative of user interactions with the representation; determine updated forecast parameters using the user input commands; execute the calculator to calculate updated forecast values using the updated forecast parameters; generate an updated forecast representation using the forecast values; and, display the updated forecast representation.

In one embodiment the one or more electronic processing devices are configured to: store updated forecast parameters in the configuration data; and, calculate the updated forecast values using the updated forecast parameters in the configuration data.

In one embodiment the one or more electronic processing devices are configured to construct a calculator using the configuration data.

In one embodiment the one or more electronic processing devices are configured to: display the forecast representation; and, repeatedly generate updated forecast representations based on user interactions with the forecast representation.

In one embodiment, between repeatedly generating updated forecast representations at least some of the forecast values are at least one of: non-persistent; not written to the persistent memory; not written to a database; held in non-persistent memory; and, are stored in RAM.

In one embodiment the one or more electronic processing devices are configured to execute the calculator by performing calculations based on accounting data.

In one embodiment the one or more electronic processing devices are configured to: retrieve accounting data from at least one of: a persistent data store; and, an accounting application; and, execute the calculator using the retrieved accounting data.

In one embodiment the forecast calculator includes executable code embodying the forecast rules.

In one embodiment the one or more forecast parameters include any one or more of: one or more selected forecasts; a forecast start date; a forecast end date; and, a forecast duration.

In one embodiment the configuration data defines: a baseline forecast; one or more micro-forecasts, each micro-forecast being indicative of a specific event; a main scenario based on the baseline forecast and including one or more micro-forecasts; and, one or more alternative scenarios, each alternative scenario being based on a modification to the baseline forecast and optionally including one or more micro-forecasts.

In one embodiment each scenario inherits one or more values from the baseline forecast.

In one embodiment the one or more electronic processing devices are configured to: determine a selected scenario in accordance with user input commands; and, generate a representation using forecast values for the selected scenario.

In one embodiment the one or more electronic processing devices are configured to: calculate forecast values for the baseline forecast; and, generate forecast values for an alternative scenario by: inheriting forecast values from the baseline forecast; and, overriding selected ones of the forecast values depending on the scenario.

In one embodiment the configuration data includes, for each of a number of forecasts: timing profiles for collecting or making payments; schedules for loans and depreciation; and, custom journals defined in accordance with user input commands.

In one embodiment the forecast representation includes at least one of: a graphical representation of the forecast values; and, a numerical representation of the forecast values.

In one embodiment the graphical representation includes a chart showing a plurality of events within the forecast, each event being represented by respective bars, and the bars being arranged relative to a timeline.

In one embodiment at least one bar is a micro-forecast bar indicative of a micro-forecast.

In one embodiment micro-forecast bar includes a plurality of markers indicative of impacts of the micro-forecast.

In one embodiment a size of each marker is indicative of a size of the impact.

In one embodiment the impacts include at least one of: a change in cash; a change in assets; a change in equity; a change in non-cash assets; and a change in liabilities.

In one embodiment the one or more electronic processing devices are configured to: determine a selected one of a number of impacts in accordance with user input commands; and, generate the markers in accordance with the selected impact.

In one embodiment the forecast is a financial forecast.

In one embodiment the system is configured to at least one of: dynamically display the forecast; and, optimise the dynamic display of the forecast; and, optimise calculations to allow the forecast to be dynamically displayed.

In one embodiment the method includes, in the one or more electronic processing devices: acquiring user input commands via the input, the user input commands being indicative of user interactions with the representation; determining updated forecast parameters using the user input commands; executing the calculator to calculate updated forecast values using the updated forecast parameters; generating an updated forecast representation using the forecast values; and, displaying the updated forecast representation.

In one embodiment the method includes, in the one or more electronic processing devices: storing updated forecast parameters in the configuration data; and, executing the calculator to calculate updated forecast values using the configuration data.

In one embodiment the method includes executing the calculator using CPU and RAM.

In one embodiment the forecast values are at least one of: non-persistent; not written to a database; not written to the persistent memory; held in non-persistent memory; and, are stored in RAM.

It will be appreciated that the broad forms of the invention and their respective features can be used in conjunction and/or independently, and reference to separate broad forms is not intended to be limiting. Furthermore, it will be appreciated that features of the method can be performed using the system or apparatus and that features of the system or apparatus can be implemented using the method.

### BRIEF DESCRIPTION OF THE DRAWINGS

Various examples and embodiments of the present invention will now be described with reference to the accompanying drawings, in which: -

FIG. 1 is a schematic diagram of an example of a computer system;

FIG. 2 is a flow chart of an example of a method for performing forecasting using a computer system;

FIG. 3 is a schematic diagram of a distributed computer architecture;

FIG. 4 is a schematic diagram of an example of a client device;

FIGS. 5A and 5B are a flow chart of a further example of a method for performing forecasting using a computer system;

FIGS. 6A to 6C are schematic diagrams of examples of representations of forecasts; and,

FIGS. 7A to 7E are schematic diagrams of examples of roadmap representations of forecasts.

### DETAILED DESCRIPTION OF THE PREFERRED EMBODIMENTS

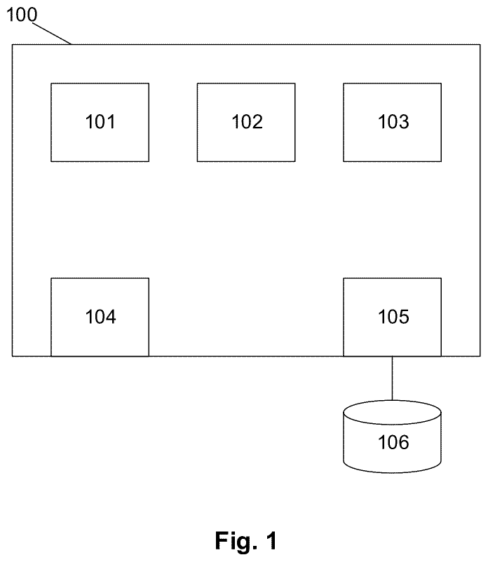

An example of a processing system, such as a computer system, for use in forecasting will now be described with reference to FIG. 1.

In this example, the processing system 100 includes at least one processing device 101, such as a Central Processing Unit (CPU), a non-persistent memory 102, such as Random Access Memory (RAM) and a persistent memory 103, such as a solid state drive (SSD), hard disk drive (HDD), or similar. The processing system 100 also includes an input/output device 104, such as a keyboard and/or display, touchscreen, or similar, and an external interface 105. The external interface 105 can be utilised for connecting the processing system 100 to peripheral devices, such one or more communications networks, databases 106, such as networked database, other storage devices, or the like. Although a single external interface 105 is shown, this is for the purpose of example only, and in practice multiple interfaces using various methods (e.g. Ethernet, serial, USB, wireless or the like) may be provided.

In use, the microprocessor 101 executes instructions in the form of applications software stored in the persistent memory 103 to allow the required processes to be performed. The applications software may include one or more software modules, and may be executed in a suitable execution environment, such as an operating system environment, or the like.

Accordingly, it will be appreciated that the processing system 100 may be formed from any suitable processing system, such as a suitably programmed client device, PC, web server, network server, or the like. In one particular example, the processing system 100 is a standard processing system such as an Intel Architecture based processing system, which executes software applications stored on non-volatile (e.g., hard disk) storage, although this is not essential. However, it will also be understood that the processing system could be any electronic processing device such as a microprocessor, microchip processor, logic gate configuration, firmware optionally associated with implementing logic such as an FPGA (Field Programmable Gate Array), or any other electronic device, system or arrangement.

For the purpose of illustration, whilst reference is made to a single processing system, in practice multiple processing systems might be provided, with processing performed by one or more of the processing systems. Similarly, whilst a processing system may include a single processing device 101, in other examples, multiple processing devices might be used, with processing split between the processing devices 101 as needed. For example, processing could be split between a CPU and a graphical processing unit (GPU), multi-threaded execution could be used allowing multiple cores of the CPU to be used simultaneously to speed up the calculation, or processing could be split between multiple processing systems. Similarly, although a stand-alone processing system is described with reference to FIG. 1, distributed architectures could be used, as will be described in more detail below.

Accordingly, for the purpose of ease of illustration, the following examples will refer to a single processing system and single processing device, but it will be appreciated that reference to a singular processing system of device should be understood to encompass multiple processing systems and/or devices and vice versa, with processing being distributed between the devices as appropriate.

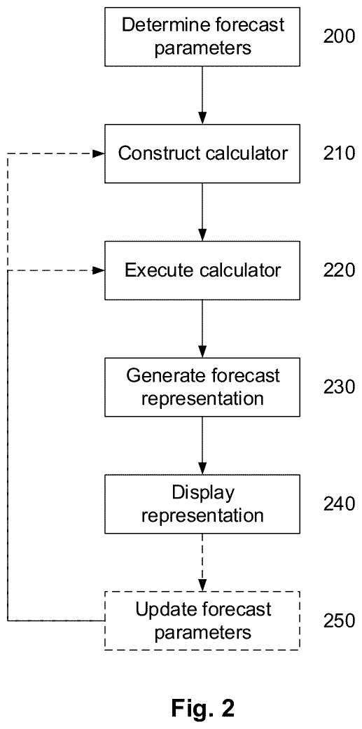

An example of a forecasting process will now be described with reference to FIG. 2.

For the purpose of this example, it is assumed that the processing system 100 is storing configuration data in the persistent memory 103, with the configuration data including forecast rules for calculating forecast values. The forecast rules set out how values in the forecast should be calculated, and may be based on an underlying data set, such as historical accounting data and/or may include generic rules, such as setting an annualized rate of growth. For example, the rules can define the cost of manufacture and distribution of products, the revenue resulting of sales of the product if the product has separate/exclusive revenue and cost account lines, typical expenses such as the cost of salaries within an organisation, or the like. The configuration data could be generated in any suitable manner, and in one example is generated using analysis of historical accounting data. As such techniques are known, these will not be described in further detail.

In this example, at step 200 the processing device 101 determines one or more forecast parameters based on user input commands received via the input 104. The forecast parameters are effectively any input that is used to control the forecast that is generated. For example, at a basic level, the forecast parameters could include selection of a forecast that is to be prepared and/or relevant timing, such as a start date, end date, duration of the forecast, or the like. However, as will be described in more detail below, the forecast parameters could define whether a baseline forecast or one or more scenario forecasts are used, and also whether one or more micro-forecasts are to be included.

At step 210, the processing device 101 constructs a calculator using the configuration data and the forecast parameters. The manner in which this is achieved will vary depending on the preferred implementation, but will typically involve generating code embodying the forecast rules from the configuration data, so that when the calculator is executed, this causes forecast values to be calculated. In one example, the calculator is constructed using a general purpose programming language such as C#, although this is not essential and other suitable arrangements could be used.

At step 220, the processing device 101 executes the calculator thereby causing the forecast values to be generated. This execution step can be performed based on accounting data (“actuals”) captured from an accounting system and/or retrieved from a persistent data store, and which are indicative of a current financial state of the operation, allowing forecast from that point forward to be generated. However, it will be appreciated that this is not essential, and will depend on the information embodied within the configuration data. The calculation process is performed by the processing device 101, with the resulting forecast values being held in non-persistent memory, avoiding the need to write the results to persistent memory. Coding methods such as index-based lookup collections, such as HashSets or dictionaries could be used to further optimise the speed of calculation, for example to facilitate retrieval of calculated values used in subsequent calculation steps. The calculation step can also generate information regarding how the forecast values are calculated, which can be stored together with the forecast values in non-persistent memory, allowing this to act as audit information, so that the calculated values can be subsequently verified.

At step 230, the processing device generates a forecast representation based on the forecast values, with this being displayed to a user at step 240. The nature of the representation and the manner in which this is generated will vary depending on the preferred implementation and/or user preferences. For example, the representation could include a numerical representation, similar in appearance to a spreadsheet, with rows and columns of numbers representing the forecast values. Alternatively, a graphical representation, such as bar chart or similar could be generated. In general, this is achieved using user configurable templates available to the software application, which are then populated with the forecast values, as would be appreciated by persons skilled in the art.

Whilst the process could end at this point, more typically a user will want to manipulate the forecast to understand how changes in one or more parameters could impact on the forecast. For example, this might involve adjusting the timing of a micro-forecast, changing a magnitude of product sales, adjusting timing profiles for payment collection, driver value adjustments, switching between scenarios, or the like. In this instance, the processing device 101 can determine updated forecast parameters at step 250 based on the user input. This can advantageously be achieved through user interaction with the representation, for example, by having a user manually update one or more numerical values, or by having the user adjust the timing of events in the graphical representation.

Having determined updated forecast parameters, the process can return to step 210 or step 220, allowing the calculator to be reconstructed and/or re-run based on the updated forecast parameters. As part of this, updated forecast values are generated and stored in the non-persistent memory, with this process effectively overwriting the previously generated forecast values. As the previous values have not been stored in persistent memory, these are no longer available for retrieval, although it will be noted that these can be readily re-created by running the calculator again based on the configuration data, and using the original forecast parameters.

Accordingly, the above described arrangement operates by storing configuration data in a persistent memory, which can be used to calculate forecast values. The configuration data is typically a small rule set and hence the process of storing, accessing, retrieving or updating the configuration data is trivial from the perspective of the time taken. Nevertheless, once the configuration data has been created, a calculator can be constructed based on the configuration data, which allows forecast values to be calculated. This can be based on an underlying dataset, such as previous accounting data, although it will be appreciated that this is not essential, and may not occur for example, in the case of forecast for new operations, or where formulas are used to derive values, such as the cost of a product being set at 60% of a sales price.

The calculator can be executed using the processing device 101 and non-persistent memory 102, with the forecast values being generated and held within non-persistent memory 102 as part of the execution process. Following this, the forecast values are used to generate a representation, which can then be displayed to the user via the input/output device 104, allowing the user to view and interact with the forecast. Interactions with the forecast that change the forecast cause the calculator to be re-executed, generating updated forecast values, which are in turn used to generate an updated representation.

This, it will be appreciated that throughout the above described process, the forecast values are not persistent, in that they do not need to be written to persistent memory 103, and instead can be held in non-persistent memory 102, such as RAM. As the write time to RAM is lower and has significantly less latency than writing to persistent memory, this vastly reduces the time involved in generating the forecast and allows more detailed information about how a value is calculated to be presented so that this can act as audit information. Whilst this has the disadvantage of historical forecasts no longer being accessible, these can simply be recalculated substantially in real time by using the stored configuration data and similar forecast parameters.

Conversely, not writing the large volume of generated forecast values and other associated data into the persistent memory 103, instead executing a calculator to generate the forecast values, means that alterations to the forecast can be generated substantially in a real time. Thus, calculation is optimised to allow the forecasts to be displayed dynamically, so that a user can manipulate forecasts via the representation and view the impact of these manipulations substantially in real time. This in turn helps the user more easily understand the forecast, and how this could be adjusted to achieve desired outcomes, whilst overcoming the technical drawback of existing approaches in which forecast values are written into persistent memory.

A further benefit of the above described approach, is that as forecast values are re-calculated each time a forecast is viewed, this ensures the forecast values are based on the latest available accounting data. Thus, as accounting data is updated in an accounting system, this can be retrieved and used as the basis for a forecast calculation, ensuring the forecast is as up to date as possible.

It will be appreciated that throughout the above that reference is made to not storing the forecast values in persistent memory, allowing forecasts to adapted rapidly, for example in response to user inputs adjusting the selection and timing of micro-forecasts, or the like. This allows users to repeatedly generate a number of different forecasts as a result of user interaction with the representation, ultimately enabling them to identify forecasts that are particularly suited for their needs. During this process, at least some of, if not all, forecast values are non-persistent, and hence are not written to the persistent memory or a database, thereby increasing the rate at which the repeated forecasts can be generated and reviewed, allowing dynamic display of forecasts to be optimised. In particular this allows forecasts to be updated and displayed in real-time, overcoming the technical limitations associated with the traditional approach of writing to and reading from persistent memory. However, it will be appreciated that once the user has identified forecasts of interest, the user could then elect to store one or more of these resulting forecasts in persistent memory, if desired, and this should not be considered as being excluded as an option for the above described process.

A number of further features will now be described.

In one example, the one or more electronic processing devices 101 are configured to store the forecast parameters as part of the configuration data, and then calculate the forecast values using the forecast parameters in the configuration data. Updating the configuration data in this manner takes little time, even though it is stored in persistent memory 103, given the low volume of data involved. Nonetheless, this allows the forecast to be generated based on the configuration data, so if it is desired to recreate a last previous forecast, this can be done simply by using the most recent configuration data. However, this is not essential, and alternatively forecast parameters based on user input could be stored separately to the configuration data, in either persistent or non-persistent memory 103, 102.

As mentioned above, in one example, a user is able to interact with the representation to allow the forecast to be updated. In general this is achieved by having the processing device 101 acquire user input commands via an input, such as the input/output device 104, with the user input commands being indicative of user interactions with the representation. The input commands are then used by the processing device 101 to determine updated forecast parameters. For example, the user could interact with the representation to adjust a start or end time of a micro-forecast, or to adjust specific values, such as sales amounts, or similar.

Having determined changes to the forecast parameters, the processing device 101 can then execute the calculator, to thereby calculate updated forecast values using the updated forecast parameters. The updated forecast values are used to generate an updated forecast representation, which can then be displayed to the user. It will be appreciated that the calculation of the forecast values can be achieved quickly, as there is no need to store the resulting values in persistent memory 103, meaning this can be performed substantially in real time, allowing the user to rapidly assess the impact changes will have on the forecast.

In general, when performing this process, the processing device 101 will store the updated forecast parameters in the configuration data and then calculate the updated forecast values using the updated forecast parameters in the configuration data, which as mentioned above incurs little delay due to this only requiring that a small amount of data stored in persistent memory is updated.

In one example the forecast calculator includes executable code embodying the forecast rules, allowing this to be run by the CPU 101 in RAM 102, thereby enabling a large volume of calculations to be performed rapidly.

In one example, the configuration data defines a number of forecasts including a baseline forecast, one or more micro-forecasts indicative of a specific event, such as hiring one or more additional team members, and one or more scenarios. The baseline forecast is intended to represent a business as usual situation and so tends to be derived using predictive modelling based on actual accounting data from previous years, whilst each scenario is intended to be based on the baseline forecast. In one example, a main scenario is provided, which is based on the baseline forecast and optionally includes one or more micro-forecasts, with alternative scenarios also be provided, which are indicative of a modification to the baseline forecast, for example to allow large scale changes or trends to be examined, such as percentage increases or decreases in sales, or the like. Again the alternative scenarios may also optionally include one or more micro-forecasts, potentially including different micro-forecasts and/or similar micro-forecasts, which may be executed at similar or different times, allowing a range of different situations to be modelled. This provides the system with a great degree of flexibility, and in particular allows a wide range of different situations to be easily modelled using a combination of the baseline, scenarios and different micro-forecasts.

Typically each scenario inherits one or more forecast values from the baseline forecast. In particular, it generally inherits all forecast values other than those that are overridden by the respective scenario. Thus, when calculating the forecast values, the processing device can generate forecast values for the baseline forecast and then generate forecast values for each scenario by inheriting forecast values from the baseline forecast and overriding selected ones of the forecast values depending on the scenario. Thus, the scenario will typically define differences to the baseline forecast, and this allows the processing device to simply re-calculate forecast values that are changed as a result of the differences. For example, if a scenario models a 5% reduction in sales, forecast values for other aspects of the business, such as wages or the like, can remain unchanged, with forecast values relating to sales can be increased or decreased as needed. This ensures the scenario is synchronised with the baseline, apart from the intended differences, and further avoids the need to maintain completely separate models for the baseline forecast and each scenario.

In contrast, each micro-forecast is a self-contained set of profit and loss and balance sheet statements that can be used to model the financial result of specific business events. Other secondary impacts, like tax impacts, area also captured in the micro-forecast, allowing it to be a complete self-contained view of the business event. All of the data in the micro-forecast is stored relative to the start position of that micro-forecast, allowing the entire dataset within the micro-forecast to be moved in time relative to the starting position of the forecast by selecting a different start time parameter. This allows scenarios to be constructed micro-forecast business events occur at different times. In general the micro-forecasts will be manually generated, although it will be appreciated that this can be based on existing accounting data, for similar events that have previously occurred. Thus, for example, a micro-forecast for hiring of a senior executive could be based on similar previous hiring events.

In one preferred example, a set of applied micro-forecasts and their timing is saved against each scenario, including the main scenario, so that all that is required is for the user to select a scenario to allow forecast values to be calculated. Thus, the selected scenario can be used to determine any required modifications to the baseline forecast, as well as the timing of any micro-forecasts, allowing these to be taken into account when constructing and executing the calculator. In this example, the processing device is configured to determine selected forecasts in accordance with user input commands, and then generate a representation using forecast values for the selected forecasts. Thus, the user can select the forecasts they wish to run, with the processing device then generating forecast values, allowing the representations to be generated.

As mentioned above, the configuration data typically includes forecast rules defining how the forecast values are generated for each forecast. The forecast rules set out how values in the forecast should be calculated, and could for example be based on predictive analysis of accounting data, and/or could include fixed rules, such as defining a fixed percentage annual increase. In one example, rules can be defined hierarchically, with high level rules being applied across broad categories or groups of values, with low level rules then being applied to some subsets. For example, a rule could be applied that increases all revenue annually by 5%, with low level rules defining that revenue for a particular source might increase by a smaller or larger amount. This can be useful in reducing the number of rules that need to be defined, and also further reducing the number of calculations required to calculate the forecast values.

The rules might also specify how to manage micro-forecasts, particularly in scenarios where an event associated with a micro-forecast has been implemented within a business. For example, if a micro-forecast for a new hire is scheduled to be implemented in June, then when forecasting after this date, effects of the hire will be present in the actual accounting data, for example with a corresponding increase in overall wages as a result of the hire. As the micro-forecast is self-contained, this situation cannot easily be accounted for within the micro-forecast. Accordingly, in this instance, the rules can specify how the baseline forecast can be modified to account for the fact that the actuals include impacts from the micro-forecast having commenced, for example reducing the wages data to remove the effect of the micro-forecast, so when the micro-forecast calculation is performed, the resulting wages are correctly calculated.

In addition, the configuration data may also include timing profiles for collecting or making payments, schedules for loans and depreciation and/or custom journals defined in accordance with user input commands. Other information, such as tax settings, other settings, user preferences, or the like, may also be stored as part of the configuration data.

The nature of the forecast representation will vary depending on the preferred implementation and/or user preferences, and could include graphical and/or numerical representations of the forecast values.

Where a graphical representation is used, this could be in the form of a chart showing a plurality of events within the forecast, each event being represented by respective bars, and the bars being arranged relative to a timeline. In this example, the representation can include a micro-forecast bar indicative of a micro-forecast. This is particularly advantageous as the position of the bar can be adjusted relative to the time line, to alter the timing associated with the micro-forecast and a corresponding business event. For example, this could be used to adjust the timing of a new hire, allowing a user to rapidly understand how adjusting the timing of a hire could impact on the resulting forecast.

The micro-forecast bar can include a plurality of markers indicative of impacts of the micro-forecast, with a size of each marker being indicative of a size of the impact. The impact could be of any appropriate form, and in one example, includes a change in cash, a change in assets, a change in equity, a change in non-cash assets, a change in liabilities, or the like, with the impact being displayed being selected by the user. Thus, for example, the bar could include circles spaced along the bar, for example a weekly, bi-weekly or monthly intervals, with larger circles indicating that the micro-forecast has a greater impact on cash flow at that time, than at other times. This can also help demonstrate that the ultimate cash movements may be timed differently to when the microforecast happens, so for example if cash is collected three months later, and then taxes may be payable several months later again. This allows a user to more readily perceive the impact that is likely to occur if the micro-forecast is moved, in turn allowing the user to more effectively update the forecasts to meet desired outcomes.

In any event, it will be appreciated that the above described processes can help optimise forecasting in a computer system, in particular by avoiding the need to write forecast values to persistent memory, this significantly reduce the time required to generate and display a forecast representation. This in turn allows the forecast representation to be feasibly used as an input mechanism, allowing a user to adjust parameters, such as start times of specific events, with the forecast values being rapidly re-calculated, so that the representation can be updated substantially in real-time, allowing users to get immediate feedback on the impact of changes on the forecast. This enables the user to more effectively understand how changes in different business events or situations can be used to achieve end goals for the business.

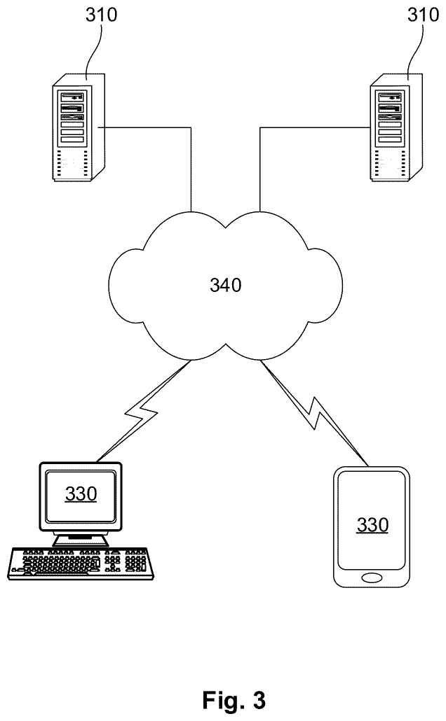

In one example, the process is performed by one or more processing systems and client devices operating as part of a distributed architecture, an example of which will now be described with reference to FIG. 3.

In this example, a number of processing systems 310 are coupled via communications networks, such as the Internet 340, and/or one or more local area networks (LANs), to a number of client devices 330. It will be appreciated that the configuration of the networks 340 are for the purpose of example only, and in practice the processing systems 310 and client devices 330 can communicate via any appropriate mechanism, such as via wired or wireless connections, including, but not limited to mobile networks, private networks, such as an 802.11 networks, the Internet, LANs, WANs, or the like, as well as via direct or point-to-point connections, such as Bluetooth, or the like.

In one example, the processing systems 310 are configured to construct and execute calculators to generate the forecast values and associated representations, with these being is provided this to a client device 330, allowing the client device 330 to display the representation. Whilst the processing systems 310 are shown as single entities, it will be appreciated that the processing system 310 can be distributed over a number of geographically separate locations, for example by using processing systems 310 and/or databases that are provided as part of a cloud based environment. However, the above described arrangement is not essential and other suitable configurations could be used.

In one example, the processing system 310 is similar to the processing system 100 described above, and this will not therefore be described in any further detail. However, it should be noted that an input/output device 104 might not be required, for example if the processing system is a server.

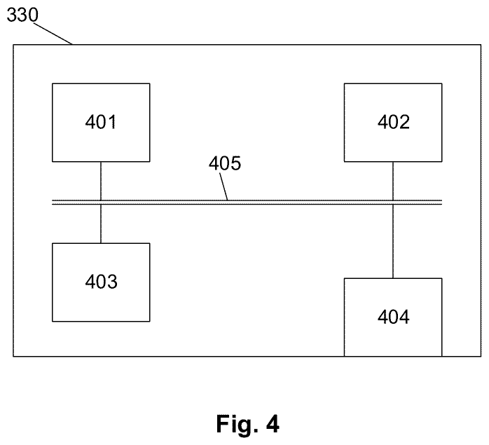

An example of a suitable client device 330 is shown in FIG. 4.

In one example, the client device 330 includes at least one microprocessor 401, a memory 402, an input/output device 403, such as a keyboard and/or display, and an external interface 404, interconnected via a bus 405 as shown. In this example the external interface 404 can be utilised for connecting the client device 330 to peripheral devices, such as the communications networks 340, databases, other storage devices, or the like. Although a single external interface 404 is shown, this is for the purpose of example only, and in practice multiple interfaces using various methods (eg. Ethernet, serial, USB, wireless or the like) may be provided.

In use, the microprocessor 401 executes instructions in the form of applications software stored in the memory 402 to allow communication with the processing system 310, for example to allow forecast values and/or representations to be received.

Accordingly, it will be appreciated that the client devices 330 may be formed from any suitable processing system, such as a suitably programmed PC, Internet terminal, lap-top, or hand-held PC, and in one preferred example is either a tablet, or smart phone, or the like. Thus, in one example, the client device 330 is a standard processing system such as an Intel Architecture based processing system, which executes software applications stored on non-volatile (e.g., hard disk) storage, although this is not essential. However, it will also be understood that the client devices 330 can be any electronic processing device such as a microprocessor, microchip processor, logic gate configuration, firmware optionally associated with implementing logic such as an FPGA (Field Programmable Gate Array), or any other electronic device, system or arrangement.

Examples of the processes for generating forecast values and displaying representations will now be described in further detail. For the purpose of these examples it is assumed that one or more processing systems 310 include a server, such as an API (application programming interface) server, that receives and interprets requests from a client device 330, taking appropriate actions, such as updating configuration data stored in a networked database, and/or generating and executing calculators as required. Resulting forecast values and representations are returned to the client device 330 for display.

In one example, to provide this in a platform agnostic manner, allowing this to be easily accessed using client devices 330 using different operating systems, and having different processing capabilities, input data and commands are received from the client devices 330 using via a webpage, with resulting visualisations being rendered locally by a browser application, or other similar application executed by the client device 330.

To achieve this the processing systems 310 typically execute applications for performing required tasks including storing and/or processing of data, with actions performed by the processing systems 310 being performed by the processor 100 in accordance with instructions stored as applications software in the memory and/or input commands received from a user via the client device 330. It will also be assumed that the user interacts with the server 310 via a GUI (Graphical User Interface), or the like presented on the client device 330, and in one particular example via a browser application that displays webpages hosted by the server 310, or an App that displays data supplied by the server 310. Actions performed by the client device 330 are performed by the processor 400 in accordance with instructions stored as applications software in the memory 401 and/or input commands received from a user via the I/O device 402.

However, it will be appreciated that the above described configuration assumed for the purpose of the following examples is not essential, and numerous other configurations may be used. It will also be appreciated that the partitioning of functionality between the client devices 330, and the server 310 may vary, depending on the particular implementation.

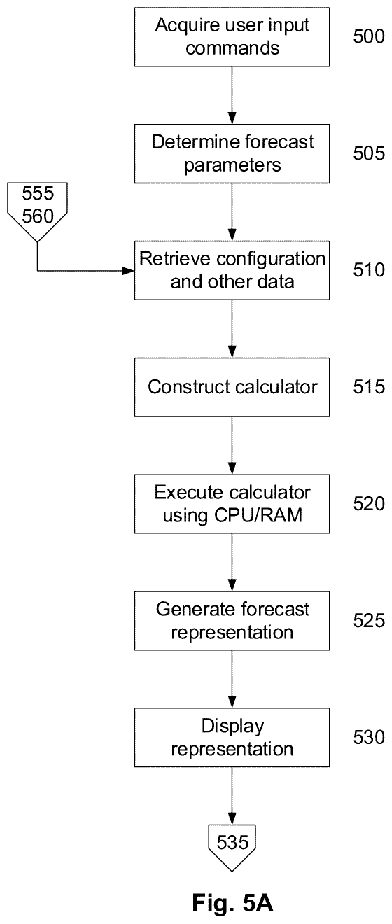

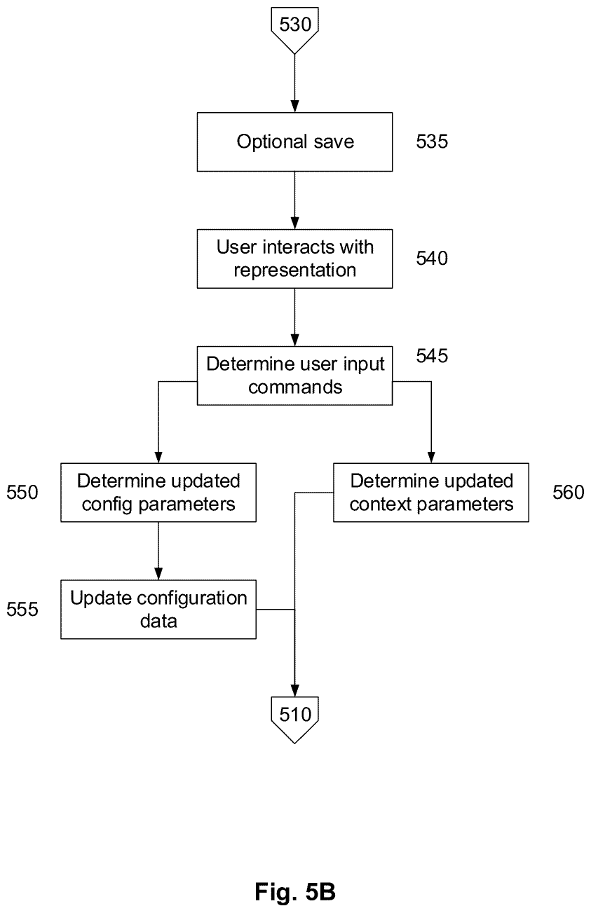

A further example of the process for performing forecasting will now be described with reference to FIGS. 5A and 5B.

In this example, at step 500, user input commands indicative of one or more forecast parameters are received, for example by having these received by the server 310 from the user client device 330. This can be achieved in any suitable manner, but typically this involves having the client device 330 present a user interface, allowing the user to enter the forecast parameters using the input/output device 403. In general, there are different types of forecast parameters, depending on the nature of the user input and the time at which the interaction occurs, including context and configuration parameters.

The context parameters are forecast parameters that define the forecast that is to be performed, and which therefore define a context associated with generation of the forecast. The context parameters could include the selection of a scenario, date range over which the forecast applies, and may optionally specify details of any other required information. In general, these context parameters are only required to initiate the forecast, and these do not therefore need to be stored, although it will be appreciated that they could be stored in persistent or non-persistent memory, depending on the preferred implementation.

Additionally, the forecast parameters can include configuration parameters that edit or modify scenarios. For example, this could involve changing baseline rules, or changing the baseline override rules in an alternative scenario and/or could involve altering the timing of micro-forecasts, etc. Accordingly, allowing these configuration parameters are used to update the scenario, and hence are stored as part of the configuration data in persistent memory. The configuration parameters could also include global settings outside of the scenarios that may be adjusted, such as tax settings, account linkages, or the like.

At this stage, the user inputs are indicative of context parameters, and so step 500 typically involves having the user make a selection of one of a number of available forecasts or scenarios, a start time or duration, and any other relevant information, such as accounting data to be used as a basis for the forecast, a type of forecast representation to be generated, or the like.

At step 505, the processing device 101 of the server 310 determines the context parameters from the user input commands and uses these to retrieve configuration data from persistent memory, such as a networked database at step 510, as well as any other required data, such accounting data. The external data could be ‘actual’ accounting data, or budget data. The budget data may be from the source accounting system as the accounting data, which often has a budget facility, but also can be loaded in separately e.g. via excel.

At step 515, the processing device 101 of the server 310 constructs a calculator. The calculator is constructed as executable code embodying the forecast rules in the configuration data, with the resulting calculations being stored as index look-up collections in RAM to allow the code to be executed by the processing device of the server 310 at step 520. This step will typically be performed in accordance with forecasting parameters, and in particular configuration parameters, stored as part of the configuration data, as well as any accounting data, and results in the generation of forecast values, which are stored in RAM 102.

At step 525, the processing device 101 generates a forecast representation using the forecast values. The nature of the forecast representation will vary depending on the user selection, and examples will be described in more detail below. The representation is then displayed to the user at step 530, via the client device 330.

It will be appreciated that in the event that the user is happy with the forecast, and wishes to save the forecast, the user may choose to save some or all of the forecast values at step 535, allowing these to be written to persistent memory. This would typically only occur after several iterations of interaction with the forecast, and indeed may not be required if the user is happy to simply recreate the forecast based on the configuration data. In the event that forecast values are saved, this could include all forecast values, including audit information, or may only include some or parts of the forecast, depending on the preferred implementation.

At step 540, the user interacts with the representation using the input/output device 403 of the client device 330. The manner of the interaction will vary depending on the nature of the representation, and this could include altering values of data, for example by manually entering values into cells within the representation and/or could include moving bars on a chart, for example to adjust the timing of a micro-forecast, as will be described in more detail below. An indication of the interaction is provided to the server 310, with the processing device 101 of the server 310 interpreting the user input commands at step 545, and using this to determine updated forecast parameters.

In this instance, the forecast parameters could include context parameters and/or could include configuration parameters. If the user inputs are indicative of configuration changes, for example if the user has altered timing of a micro-forecast, then updated configuration parameters are determined by the processing device 101 of the server 310 at step 550. The configuration parameters are then used to update the configuration data stored in persistent memory, such as the networked database at step 555. Alternatively, if the forecast parameters are context parameters, for example, if the user has selected a different scenario and/or forecast date range, then the updated context parameters are determined at step 560.

Following this, the process can return to step 510, allowing the server 310 to retrieve the configuration data (which optionally might have been updated), construct and execute a calculator, thereby generating updated forecast values, which can be displayed by repeating steps 510 to 530. Thus, it will be appreciated that as forecast parameters are updated, the calculator is re-constructed using the configuration data. In the case the forecast parameters are configuration parameters, then this will involve using updated configuration data, whereas if the forecast parameters are context parameters, this will involve updating using the new context.

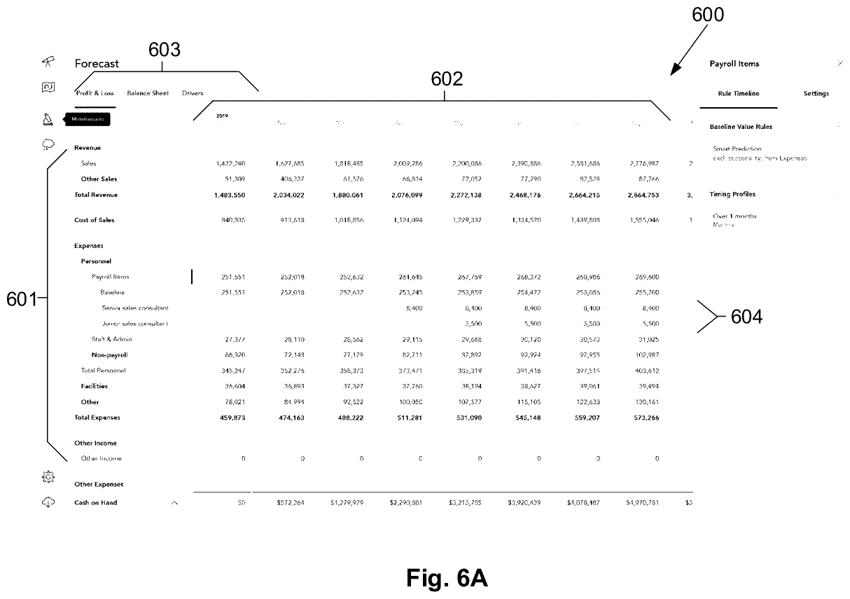

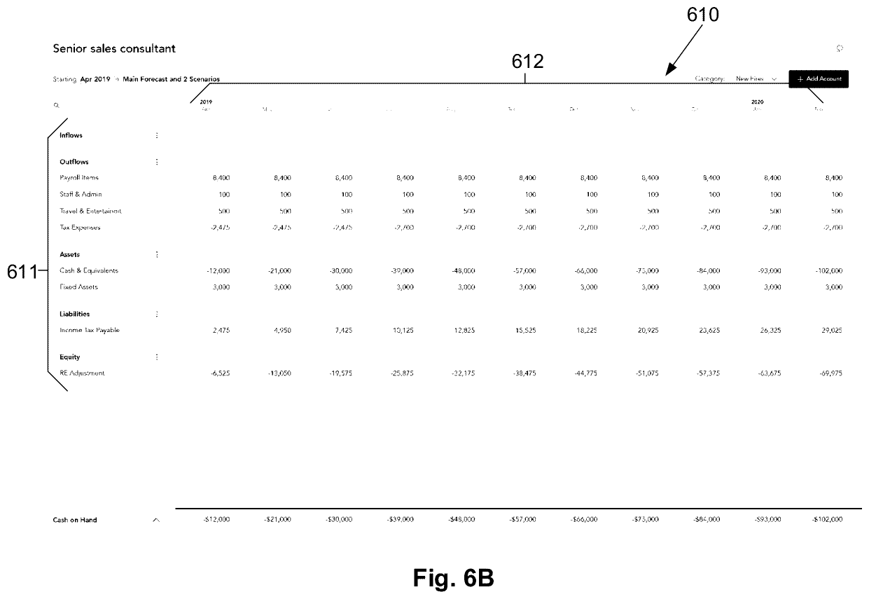

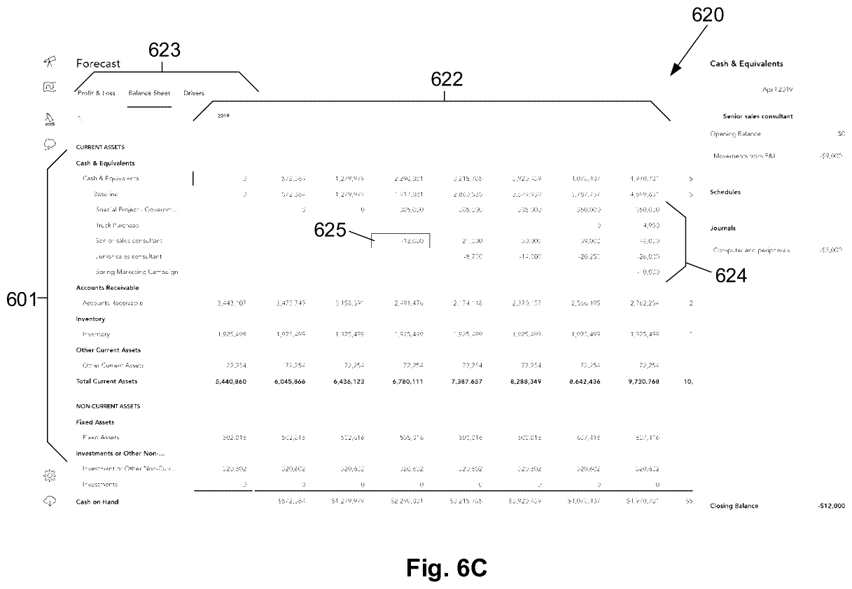

A number of specific features of the baseline and micro-forecasts will now be described with reference to FIGS. 6A to 6C, which show example forecast representations.

In FIG. 6A, the forecast representation 600 is in the form of profit and loss grid, including a number of rows 601, representing specific line items in the forecast, and a number of columns 602, representing respective calendar months, with each cell in the forecast including a respective forecast value. Tabs 603 are provided that allow a user to view different parts of the forecast, including a balance sheet and drivers, a cash flow statement, or the like.

In this example, the forecast includes baseline data, representing a foundation of the forecast, which captures business as usual movements and is generated using predictive methods based on past data received from an accounting system.

In addition to the baseline, the forecast representation 600 also includes two micro-forecasts 604, one representing hiring a junior sales consultant, and the other hiring a senior sales consultant. Each micro-forecast is a self-contained set of profit and loss and balance sheet statements, which can be used to model the financial result of specific business events. This allows for the capturing of activity in the business which is beyond the normal ‘business as usual’ forecast, such as new hires, new campaigns, changes in funding, or other business events which would otherwise change the baseline trajectory.

An example of further detail of one of the micro-forecasts is shown in FIG. 6B, with this micro-forecast representation 610 including a number of rows 611, representing specific line items in the forecast, and a number of columns 612, representing respective calendar months. The micro-forecast is defined as part of the configuration data, with the resulting forecast values shown in FIG. 6B, being calculated as part of the forecasting process.

FIG. 6A only shows the impact of the micro-forecasts on the profit and loss, but it will be appreciated that in practice the micro-forecast will also influence other accounts, both from profit and loss and balance sheet. For example, additional accounts could be added that forecast related movements, such as income earned by the employee, which would typically be a profit & loss account line, and may also be tacked separately as a balance sheet line item as well. Other secondary impacts, like tax impacts, area also captured in the micro-forecast, allowing it to be a complete self-contained view of the business event. The impacts on these other accounts will appear elsewhere in the forecast grid view, such as in the balance sheet shown in FIG. 6C.

Again, the balance sheet representation 620 includes a number of rows 621, representing specific line items in the balance sheet, and a number of columns 622, representing respective calendar months. In this example, the cash & equivalents account includes micro-forecasts 624, including the hires mentioned above and other micro-forecasts that influence this account. In this example, the senior sales consultant micro-forecast commences at 625 in April, and this will be referred to again in more detail below.

All of the data in the micro-forecast is stored relative to the start position of that micro-forecast. This allows the entire dataset within the micro-forecast to be moved in time relative to the starting position by setting a different start date, which in turn allows the entire micro-forecast to be moved in time relative to the baseline forecast. This helps the user readily understand the impact that changing the timing of the associated event will have on the forecast as a whole. For example, it is possible to create scenarios where the business event that the micro-forecast models can occur at a different time, as will be described further below.

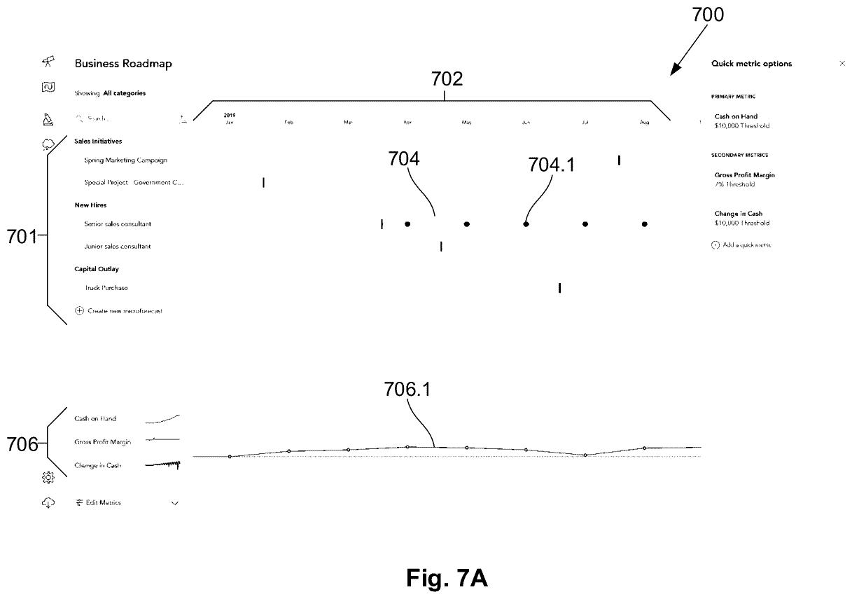

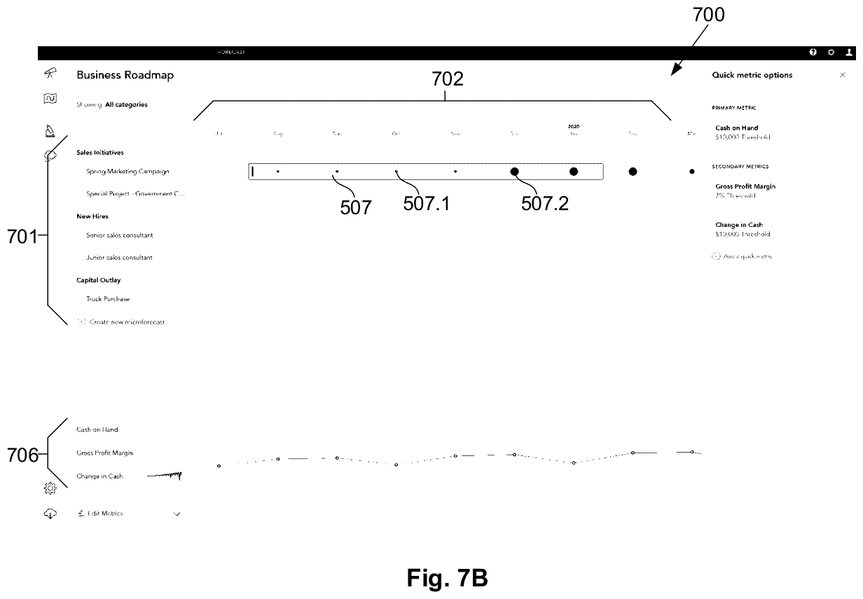

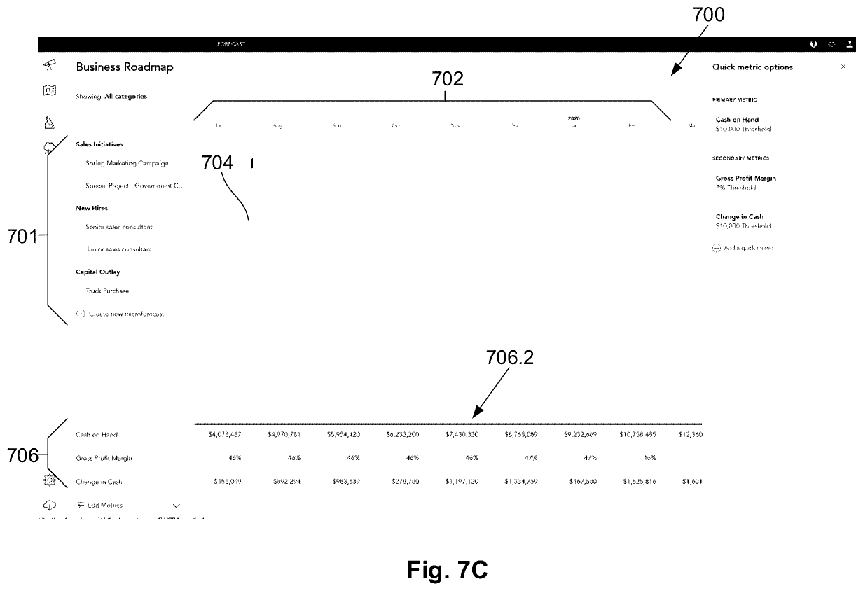

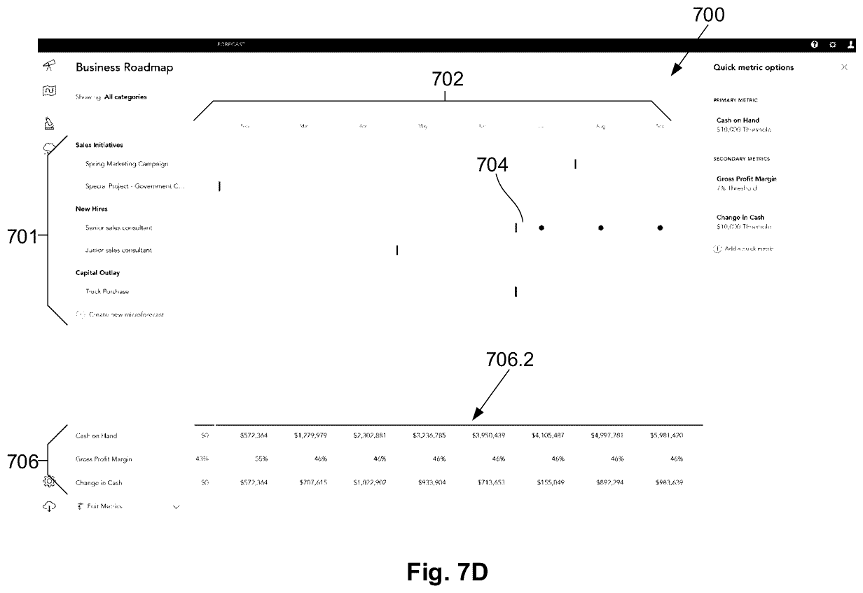

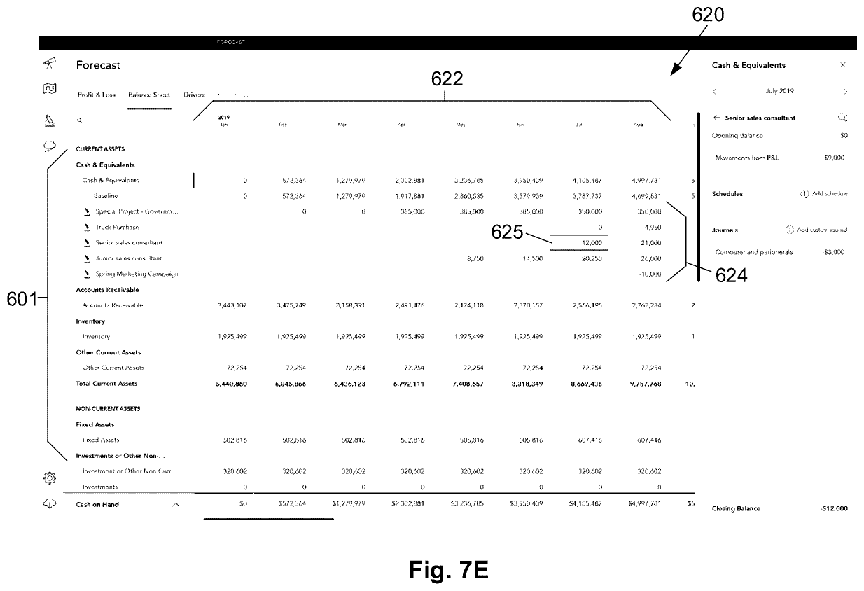

Examples of a graphical representation of the forecast in the form of a business roadmap will now be described with reference to FIGS. 7A to 7E.

In this example, the business roadmap representation 700 is a chart including a number of rows 701, representing individual micro-forecasts, and a number of columns 702, representing respective calendar months. Each row includes a bar, indicative of when a certain item in the forecast is active and/or has an impact on the forecast.

For example, in the case of the bar 704, this represents a micro-forecast associated with hiring a senior sales consultant, with the consultant being hired in April, and the micro-forecast being added to the baseline forecast from that point moving forward. The bar 704 includes a number of markers, which in this example are circles 704.1, although it will be appreciated that other marker shapes or representations could be used. The circle sizes are used to represent impacts of the micro-forecast, and are user configurable, allowing the user to configure what impacts the circle sizes represent, such as a change in cash, a gross change in assets and liabilities, or the like.

In the example of hiring the senior sales consultant, the corresponding micro-forecast has a relatively consistent impact as the bulk of the movements are a wage, which is the same from month to month. However, it will be appreciated that another micro-forecast might have different impacts and an example of this is shown in FIG. 7B.

In this example, a bar 705 for a spring marketing campaign is shown, which typically involves expending marketing funds from August to October, with a resulting increase in sales and hence cash from December to February. Thus, in the August to October period, the impact is low and the markers 705.1 are small circles, whereas in the December to February period, the impact is significantly greater, and hence the markers 705.2 are larger circles.

In each of these examples, a metrics section 706 is provided, in which the user can view a graph 706.1 on a selected one of a number of listed metrics, which are results of the respective forecast. This can alternatively be re-configured, allowing a table 706.2 to be displayed, showing the results numerically, as shown in FIG. 7C.

In addition to being able to display results, the roadmap is configurable and allows a user to alter financial forecasts. For example, each micro-forecast can be toggled on or off, or dragged in time. In each case, as the change is made, updated forecast parameters are determined based on the changes made, with the forecast results being re-calculated so that result of the changes seen almost instantaneously in the quick metrics display.

As the micro-forecast represents a business event, toggling it on and off allows the user to quickly see the impact of the business event occurring or not occurring. Dragging the business event in time allows the user to quickly see the impact of performing the business event at different times. For example, if the senior sales consultant hire bar 704 is dragged from April (FIG. 7C) to July (FIG. 7D), the metric forecast values 706.2 are updated. Additionally, in the forecast grid view 620 shown in FIG. 7E, all of the movements from the various accounts in that micro-forecast have shifted and commence in July as shown at 625 compared to the previous forecast shown in FIG. 6C.

As previously mentioned, the configuration data can store a main forecast, including a baseline, and a set of applied micro-forecasts, including associated start dates. Additionally however, one or more scenario forecasts can be defined, which represent an ‘adjusted baseline’, and an associated set of applied micro-forecasts, each including a unique start date.

Each scenario defines a respective adjusted baseline forecast, allowing various parameters, financial values, driver values, rules, cash timing profiles, or the like, to be overridden compared to the baseline. Otherwise, the scenario inherits values from the main forecast baseline, meaning the scenario baseline will stay in sync with the main forecast baseline, except where it has been overridden. This removes the overhead of having to maintain completely separate models for the main forecast and various scenarios.

Practically, this allows scenarios to adjust the baseline, for example to model a scenario in which a business earns 5% more revenue than in the main forecast. The user can then make corresponding adjustments to specific business events embodied by the micro-forecasts, for example hiring staff at different times because revenue is higher than expected allowing a faster hiring rate.

A scenario switcher allows the user to easily toggle between the main forecast and various scenarios, and in one example forecast values are calculated for both the main forecast and associated scenarios simultaneously, so switching between the scenarios and main forecasts is instantaneous. Again, it will be appreciated that in this instance the forecast values are held in RAM and are not written into persistent memory.

In the forecast grid view, switching scenarios will result in any overridden rules, timing profiles, or drivers in the scenario, being swapped out with different results, as well as the set of micro-forecasts and start dates switching as specified in this scenario. The results/graphs in the quick-metrics view are also updated accordingly. In the roadmap view, switching a scenario will result in the micro-forecasts listed being updated if required, and their starting positions may move as specified in this scenario. Again, the results/graphs in the quick-metrics view will also update accordingly.

Accordingly, the above described arrangement utilises an optimised calculation approach, in which forecast values are calculated as needed in real time, without the forecast values being stored in persistent memory. The rules needed to calculate the forecast values are stored in persistent memory as configuration data, so these can be used to re-compute forecast values on the fly, as needed.

The configuration data typically includes:
a baseline forecast including rules for calculating values, timing profiles for collecting or making payment, schedules for loans and depreciation, and custom journals entered by the user;
micro-forecasts including rules for calculating values, timing profiles for collecting or making payment, schedules for loans and depreciation, and custom journals entered by the user
a main forecast scenario including the baseline forecast and details and timings of any micro-forecasts
alternative scenarios including baseline forecast overrides overriding any of the configuration set in the baseline forecast as well as details and timings of any micro-forecasts for each alternative scenario
various global configurations e.g. account settings, tax settings

When a user wants to view the forecast, they specify a scenario (or the main forecast) and the rolling-from date. With this information, a calculator is assembled from the configuration data, and used to calculate forecast data including the forecast values. To achieve this, the calculator takes a configuration and processes the forecast data quickly using CPU/RAM, including generating detailed audit information. The resulting calculations and audit information are not stored in persistent memory, but rather are retained in RAM. The reason for this is that the volume of information in the forecast data, which includes not just results, but also detailed linkages showing how the results were calculated, is large, meaning that avoiding writing this to persistent memory saves significant time.

When a change is made to the forecast configuration, the configuration data in persistent memory is updated. As only a small amount of data requires updating, this is a light-weight data change that takes minimal time. Once completed, the calculator is executed again to generate the forecast values, including associated audit information, allowing this to be used to generate an updated representation displayed via the user interface. This avoids the heavy data transfer required to resave the forecast values including the audit information back to physical memory.

An example of how this is particularly useful is in respect of micro-forecasts. In this instance, when a user updates a start date, a single date field is changed as part of the configuration data in persistent memory. The updated configuration data, with only a small change, is then used to re-run the calculator, allowing a large number of calculations to be rapidly performed, with resulting forecast values, including audit information, being generated and used to update the representation, without these being stored in persistent memory. When next requested, the calculator can re-run the same calculation and arrive at the same result.

This approach allows the same set of forecast data to be rolled forward from any period of accounting data (“actuals”), which in turn allows a deep integration with the representations that are generated, allowing these to be updated in real time, based on user interactions with the representations.

For example a user can generate a report each month which takes the latest “actuals” data from the accounting system and rolls our forecast data forward from there. This allows the forecast data be viewed in an August report from September onwards, and the forecast data to be viewed in a September report from October onwards—- so when the September accounting data is available, a report can be generated without preventing our existing August report from generating data using the same forecasting model from a different point in time. This can include automated adjustments for income tax which are not typically captured accurately in accounting data until the end of a tax period, when tax returns are prepared for an accountant.

It will be appreciated that the above example arrangements could be implemented using stand-alone computer systems and/or networked arrangements, and that the implementation would be adapted as needed for the implementation.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers. As used herein and unless otherwise stated, the term “approximately” means ±20%.

Persons skilled in the art will appreciate that numerous variations and modifications will become apparent. All such variations and modifications which become apparent to persons skilled in the art, should be considered to fall within the spirit and scope that the invention broadly appearing before described.

The claims defining the invention are as follows:

1. A system for calculating a forecast, the system including:
a) an input configured to receive user inputs;
b) a display configured to present results of the forecast;
c) a persistent memory configured to store configuration data, the configuration data including forecast rules for calculating forecast values; and,
d) one or more electronic processing devices configured to:
i) determine one or more forecast parameters in accordance with user input commands received via the input, the forecast parameters being input indicative of the forecast to be generated;
ii) construct a calculator using the configuration data and the forecast parameters;
iii) execute the calculator to calculate forecast values;
iv) generate a forecast representation using the forecast values; and,
v) display the forecast representation.

2. A system according to claim 1, wherein the one or more electronic processing devices include a CPU (central processing unit) and the system includes RAM (random access memory), and wherein the calculator is executed using the CPU and RAM.

3. A system according to claim 1 or claim 2, wherein at least some of the forecast values are at least one of:
a) non-persistent;
b) not written to the persistent memory;
c) not written to a database;
d) held in non-persistent memory; and,
e) are stored in RAM.

4. A system according to any one of the claims 1 to 3, wherein the one or more electronic processing devices are configured to:
a) acquire user input commands via the input, the user input commands being indicative of user interactions with the representation;
b) determine updated forecast parameters using the user input commands;
c) execute the calculator to calculate updated forecast values using the updated forecast parameters;
d) generate an updated forecast representation using the forecast values; and,
e) display the updated forecast representation.

5. A system according to claim 4, wherein the one or more electronic processing devices are configured to:
a) store updated forecast parameters in the configuration data; and,
b) calculate the updated forecast values using the updated forecast parameters in the configuration data.

6. A system according to claim 5, wherein the one or more electronic processing devices are configured to construct a calculator using the configuration data.

7. A system according to any one of the claims 1 to 6, wherein the one or more electronic processing devices are configured to:
a) display the forecast representation; and,
b) repeatedly generate updated forecast representations based on user interactions with the forecast representation.

8. A system according to claim 7, wherein, between repeatedly generating updated forecast representations at least some of the forecast values are at least one of:
a) non-persistent;
b) not written to the persistent memory;
c) not written to a database;
d) held in non-persistent memory; and,
e) are stored in RAM.

9. A system according to any one of the claims 1 to 8, wherein the one or more electronic processing devices are configured to execute the calculator by performing calculations based on accounting data. system according to claim 9, wherein the one or more electronic processing devices are configured to:
a) retrieve accounting data from at least one of:
i) a persistent data store; and,
ii) an accounting application; and,
b) execute the calculator using the retrieved accounting data.

11. A system according to any one of the claims 1 to 10, wherein the forecast calculator includes executable code embodying the forecast rules.

12. A system according to any one of the claims 1 to 11, wherein the one or more forecast parameters include any one or more of:
a) one or more selected forecasts;
b) a forecast start date;
c) a forecast end date; and,
d) a forecast duration.

13. A system according to any one of the claims 1 to 12, wherein the configuration data defines:
a) a baseline forecast;
b) one or more micro-forecasts, each micro-forecast being indicative of a specific event;
c) a main scenario based on the baseline forecast and including one or more micro-forecasts; and,
d) one or more alternative scenarios, each alternative scenario being based on a modification to the baseline forecast and optionally including one or more micro-forecasts.

14. A system according to claim 13, wherein each scenario inherits one or more values from the baseline forecast.

15. A system according to claim 13 or claim 14, wherein the one or more electronic processing devices are configured to:
a) determine a selected scenario in accordance with user input commands; and,
b) generate a representation using forecast values for the selected scenario.

16. A system according to any one of the claims 13 to 15, wherein the one or more electronic processing devices are configured to:
a) calculate forecast values for the baseline forecast; and,
b) generate forecast values for an alternative scenario by:
i) inheriting forecast values from the baseline forecast; and,
ii) overriding selected ones of the forecast values depending on the scenario.

17. A system according to any one of the claims 13 to 16, wherein the configuration data includes, for each of a number of forecasts:
a) timing profiles for collecting or making payments;
b) schedules for loans and depreciation; and,
c) custom journals defined in accordance with user input commands.

18. A system according to any one of the claims 1 to 17, wherein the forecast representation includes at least one of:
a) a graphical representation of the forecast values; and,
b) a numerical representation of the forecast values.

19. A system according to claim 18, wherein the graphical representation includes a chart showing a plurality of events within the forecast, each event being represented by respective bars, and the bars being arranged relative to a timeline.

20. A system according to claim 19, wherein at least one bar is a micro-forecast bar indicative of a micro-forecast.

21. A system according to claim 20, wherein micro-forecast bar includes a plurality of markers indicative of impacts of the micro-forecast.

22. A system according to claim 21, wherein a size of each marker is indicative of a size of the impact.

23. A system according to claim 22, wherein the impacts include at least one of:
a) a change in cash;
b) a change in assets;
c) a change in equity;
d) a change in non-cash assets; and
e) a change in liabilities.

24. A system according to any one of the claims 21 to 23, wherein the one or more electronic processing devices are configured to:
a) determine a selected one of a number of impacts in accordance with user input commands; and,
b) generate the markers in accordance with the selected impact.

25. system according to any one of the claims 1 to 24, wherein the forecast is a financial forecast.

26. A system according to any one of the claims 1 to 25, wherein the system is configured to at least one of:
a) dynamically display the forecast; and,
b) optimise the dynamic display of the forecast; and,
c) optimise calculations to allow the forecast to be dynamically displayed.

27. A method for calculating a forecast in a computer system, the method including:
a) storing configuration data in a persistent memory, the configuration data including forecast rules for calculating forecast values; and,
b) in one or more electronic processing devices of the computer system:
i) determining one or more forecast parameters in accordance with user input commands received via an input, the forecast parameters being input indicative of the forecast to be generated;
ii) constructing a calculator using the configuration data and the forecast parameters;
iii) executing the calculator to calculate forecast values;
iv) generating a forecast representation using the forecast values; and,
v) displaying the forecast representation.

28. A method according to claim 27, wherein the method includes, in the one or more electronic processing devices:
a) acquiring user input commands via the input, the user input commands being indicative of user interactions with the representation;
b) determining updated forecast parameters using the user input commands;
c) executing the calculator to calculate updated forecast values using the updated forecast parameters;
d) generating an updated forecast representation using the forecast values; and,
e) displaying the updated forecast representation.

29. A method according to claim 27 or claim 28, wherein the method includes, in the one or more electronic processing devices:
a) storing updated forecast parameters in the configuration data; and,
b) executing the calculator to calculate updated forecast values using the configuration data.

30. A method according to any one of the claims 27 to 29, wherein the method includes executing the calculator using CPU and RAM.

31. A method according to any one of the claims 27 to 30, wherein the forecast values are at least one of:
a) non-persistent;
b) not written to the persistent memory;
c) not written to a database;
d) held in non-persistent memory; and,
e) are stored in RAM.

32. A computer program product for calculating a forecast, the computer program product including computer executable code that when executed by one or more suitably programmed processing devices causes the processing devices to:
a) determine one or more forecast parameters in accordance with user input commands received via an input, the forecast parameters being input indicative of the forecast to be generated;
b) construct a calculator using configuration data including forecast rules for calculating forecast values and the forecast parameters;
c) execute the calculator to calculate forecast values;
d) generate a forecast representation using the forecast values; and,
e) display the forecast representation.

33. A system for optimising dynamic display of a financial forecast, the system including:
a) an input configured to receive user inputs;
b) a display configured to present results of the forecast;
c) a persistent memory configured to store configuration data, the configuration data including forecast rules for calculating forecast values; and,
d) one or more electronic processing devices configured to:
i) determine one or more forecast parameters in accordance with user input commands received via the input, the forecast parameters being input indicative of the forecast to be generated;
ii) construct a calculator using the configuration data and the forecast parameters;
iii) execute the calculator to calculate forecast values;
iv) generate a forecast representation using the forecast values; and,
v) display the forecast representation.

34. A method for optimising dynamic display of a financial forecast in a computer system, the method including:
a) storing configuration data in a persistent memory, the configuration data including forecast rules for calculating forecast values; and,
b) in one or more electronic processing devices of the computer system:
i) determining one or more forecast parameters in accordance with user input commands received via an input, the forecast parameters being input indicative of the forecast to be generated;
ii) constructing a calculator using the configuration data and the forecast parameters;
iii) executing the calculator to calculate forecast values;
iv) generating a forecast representation using the forecast values; and,
v) displaying the forecast representation.

35 A computer program product for optimising dynamic display of a financial forecast, the computer program product including computer executable code that when executed by one or more suitably programmed processing devices causes the processing devices to:
a) determine one or more forecast parameters in accordance with user input commands received via an input, the forecast parameters being input indicative of the forecast to be generated;
b) construct a calculator using configuration data including forecast rules for calculating forecast values and the forecast parameters;
c) execute the calculator to calculate forecast values;
d) generate a forecast representation using the forecast values; and,
e) display the forecast representation.
